(19) United States
(12) Patent Application Publication
(10) Pub. No.: US 2025/0071225 A1
(43) Pub. Date: Feb. 27, 2025

(54) INFORMATION PROCESSING APPARATUS AND INFORMATION PROCESSING METHOD

(71) Applicant: CANON KABUSHIKI KAISHA, Tokyo (JP)

(72) Inventor: YUKARI AKIYAMA, Kanagawa (JP)

(21) Appl. No.: 18/810,667

(22) Filed: Aug. 21, 2024

(30) Foreign Application Priority Data
Aug. 25, 2023 (JP) 2023-137399

(51) Int. Cl. H04N 1/21; H04N 1/44

(52) U.S. Cl. CPC H04N 1/217; H04N 1/4493; H04N 2201/0094

(57) ABSTRACT

An information processing apparatus includes a generating unit configured to generate second image data by executing masking processing on first image data, an obtaining unit configured to separately obtain a designation of a first storage destination and a designation of a second storage destination from a user, and a storing unit configured to store the first image data in the first storage destination and the second image data in the second storage destination.

### BACKGROUND OF THE INVENTION

### Field of the Invention

The present invention relates to an information processing apparatus and an information processing method.

### Description of the Related Art

When images including personal information and confidential information are shared with others, processing is executed to conceal the portions containing such information. This processing is referred to as masking processing. Japanese Patent No. 4977242 describes a technique for enabling correction of the position of the target of masking processing after the fact by storing pre-masking-processing image data together with post-masking-processing image data. However, with this technique, a designation of the storage destination for both the post-masking-processing image data and the pre-masking-processing image data cannot be accepted from a user.

### SUMMARY OF THE INVENTION

According to some embodiments, an information processing apparatus comprising: a generating unit configured to generate second image data by executing masking processing on first image data; an obtaining unit configured to separately obtain a designation of a first storage destination and a designation of a second storage destination from a user; and a storing unit configured to store the first image data in the first storage destination and the second image data in the second storage destination is provided.

Further features of the present invention will become apparent from the following description of exemplary embodiments with reference to the attached drawings.

### BRIEF DESCRIPTION OF THE DRAWINGS

FIG. 1 is a block diagram for describing an example of the overall configuration and the hardware configuration of a first embodiment.

FIG. 2 is a block diagram for describing an example of the software configuration of the first embodiment.

FIG. 3 is a flow diagram for describing an example of an information processing method of the first embodiment.

FIGS. 4A and 4B are schematic views for describing examples of an initial screen and a preset selection screen of the first embodiment.

FIG. 5 is a schematic view for describing an example of a scan execution screen of the first embodiment.

FIGS. 6A and 6B are schematic views for describing examples of a region setting screen of the first embodiment.

FIG. 7 is a schematic view for describing an example of region information of the first embodiment.

FIG. 8 is a schematic view for describing an example of an output confirmation screen of the first embodiment.

FIGS. 9A and 9B are schematic views for describing examples of a storage destination settings screen of the first embodiment.

FIG. 10 is a schematic view for describing a name settings screen of the first embodiment.

FIG. 11 is a schematic view for describing an example of preset information of the first embodiment.

FIG. 12 is a schematic view for describing an example of an output confirmation screen of a second embodiment.

FIG. 13 is a flow diagram for describing storing operations of the second embodiment.

FIGS. 14A and 14B are schematic views for describing examples of an output confirmation screen of a third embodiment.

FIGS. 15A to 15D are schematic views for describing examples of a folder configuration of the third embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

### System Configuration and Hardware Configuration

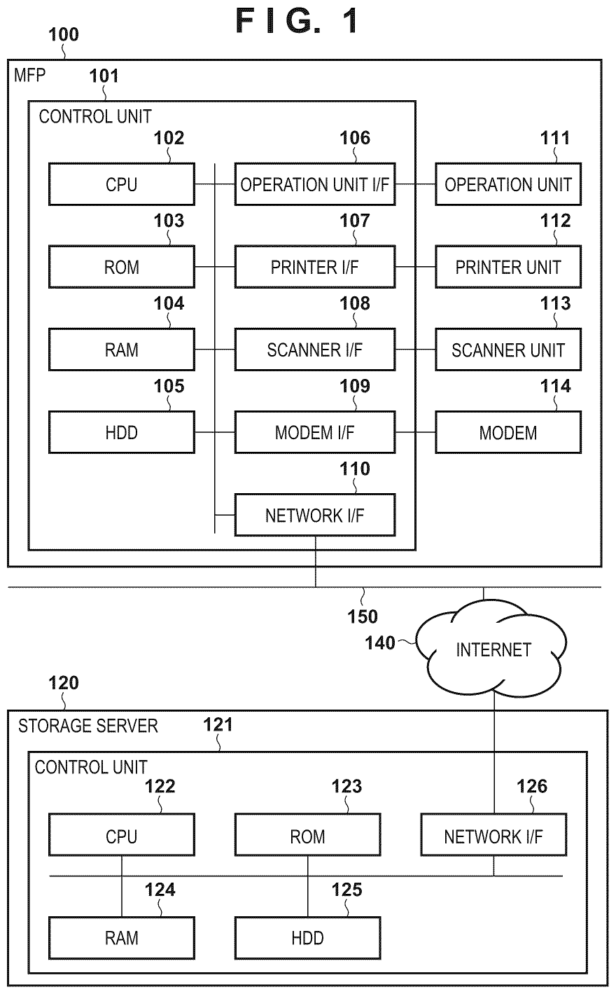

The overall configuration and hardware configuration of an image processing system according to the first embodiment will now be described with reference to FIG. 1. The image processing system may include a multi-function peripheral (MFP) 100 and a storage server 120. The image processing system may also include other apparatuses. The MFP 100 is connected to the Internet 140 via a local area network (LAN) 150. The storage server 120 is also connected to the Internet 140. The MFP 100 can communicate with the storage server 120 via the Internet 140 and the LAN 150.

The MFP 100 is an apparatus with a plurality of main functions such as a scan function and a print function. The MFP 100 is an example of an image forming apparatus. Instead of the MFP 100, an apparatus (a single-function machine) with only a scan function as a main function may be used. The MFP 100 also has a function for transferring image data to the storage server 120. Image data may be data representing an image. Image data is obtained by the MFP 100 scanning a document, for example. Only one MFP 100 is illustrated in FIG. 1, but the image processing system may include a plurality of MFPs.

The storage server 120 provides a storage service for the one or more client apparatuses including the MFP 100. Storage service may refer to a service for storing data received from a client apparatus via the Internet 140, a service for provide stored data in response to a request from a client apparatus, and the like. The storage area provided by the storage service may be referred to as storage. The client apparatus may access the storage server 120 using a web browser or a dedicated application. For example, the storage server 120 may provide an interface based on a protocol such as representational state transfer (REST), SOAP, or the like. Via this interface, the client apparatus may store data in the storage server 120, may read out stored data from the storage server 120, and the like. The storage service may also be referred to as online storage. In the examples described below, the storage server 120 manages data in a file format. Alternatively, the storage server 120 may manage data in a different format. Only one storage server 120 is illustrated in FIG. 1, but the image processing system may include a plurality of storage servers. The plurality of storage servers may each provide a different storage service. The MFP 100 may be able to use such a plurality of storage services.

The storage server 120 may be disposed in a cloud environment or may be disposed in an on-premises environment. In the example of FIG. 1, the MFP 100 can communicate with the storage server 120 via the Internet 140 and the LAN 150. Alternatively, the storage server 120 may be connected to the LAN 150. In this case, the MFP 100 can communicate with the storage server 120 without using the Internet 140. Also, the MFP 100 may have the storage function of the storage server 120. In this case, the MFP 100 stores image data in itself instead of storing image in the storage server 120. Instead of the storage server 120, another apparatus may be image data transmitted from the MFP 100. For example, the MFP 100 may transmit image data to a mail server attached to an email, and the email server may store the image data.

The hardware configuration of the MFP 100 will now be described. The MFP 100 includes a control unit 101, an operation unit 111, a printer unit 112, a scanner unit 113, and a modem 114. The control unit 101 controls the operations of the entire MFP 100. The control unit 101 functions as an information processing apparatus. The control unit 101 may include components 102 to 110. The control unit 101 may not include one or more of the components 102 to 110 and may include components that are not the components 102 to 110.

A central processing unit (CPU) 102 controls the operations of the entire control unit 101. For example, the CPU 102 reads out a control program stored in a read-only memory (ROM) 103 or a hard disk drive (HDD) 105 onto a random-access memory (RAM) 104 and executes the read out control program. The control program specifies the actions of the plurality of functions (for example, read, print, communicate, and the like) of the MFP 100. The RAM 104 is used as a temporary storage area, for example, the main memory of the CPU 102, a working area, and the like. Only one CPU 102 is illustrated in FIG. 1. Alternatively, the control unit 101 may include a plurality of CPUS, and the plurality of CPUs may cooperate to implement the operations of the control unit 101. The same applies for the ROM 103 and the RAM 104.

The HDD 105 is a secondary storage device that stores image data and various programs. An operation unit interface (I/F) 106 is an interface for connecting the operation unit 111 and the control unit 101. The operation unit 111 is a device that obtains input (for example, an instruction or the like) from the user of the MFP 100 and outputs information to the user. Hereinafter, the user of the MFP 100 may be simply referred to as the user. The operation unit 111 may be configured of a touch panel, a keyboard, a button, a display, and the like, for example. A touch panel and a display may be integrally formed as a touch screen.

A printer I/F 107 is an interface for connecting the printer unit 112 and the control unit 101. Image data for printing is transferred from the control unit 101 to the printer unit 112 via the printer I/F 107 and is printed on a printing medium. A scanner I/F 108 is an interface for connecting the scanner unit 113 and the control unit 101. The scanner unit 113 reads a document set on a not-illustrated platen glass or auto document feeder (ADF) to generate image data and inputs the image data to the control unit 101 via the scanner I/F 108. The MFP 100 may print (copy) the image data generated by the scanner unit 113 from the printer unit 112. Instead of or in addition to, the MFP 100 may transmit the image data to the storage server 120 or may transmit the image data to an email server attached to an email.

A modem I/F 109 is an interface for connecting the modem 114 and the control unit 101. The modem 114 transmits the image data to a facsimile machine via a public switched telephone network (PSTN). A network I/F 110 is an interface for connecting the control unit 101 to the LAN 150. The MFP 100 transmits image data and information to the services on the Internet 140 and receives various types of information using the network I/F 110.

The hardware configuration of the storage server 120 will now be described. The storage server 120 may include a control unit 121. The control unit 121 controls the operations of the entire storage server 120. The control unit 121 functions as an information processing apparatus. The control unit 121 may include components 122 to 126. The control unit 121 may not include one or more of the components 122 to 126 and may include components that are not the components 122 to 126.

A CPU 122 controls the operations of the entire control unit 121. For example, the CPU 122 reads out a control program stored in a ROM 123 or a HDD 125 onto a RAM 124 and executes the read out control program. The control program specifies the actions of the plurality of functions (for example, store, read out, communicate, and the like) of the storage server 120. The RAM 124 is used as a temporary storage area, for example, the main memory of the CPU 122, a working area, and the like. Only one CPU 122 is illustrated in FIG. 1. Alternatively, the control unit 121 may include a plurality of CPUS, and the plurality of CPUs may cooperate to implement the operations of the control unit 121. The same applies for the ROM 123 and the RAM 124.

The HDD 125 is a secondary storage device that stores image data and various programs. A network I/F 126 is an interface for connecting the control unit 121 to the Internet 140. The storage server 120 receives requests from other apparatuses (the MFP 100 and the like) via the network I/F 126 and transmits and receives various types of information in response to these requests.

### Software Configuration of MFP

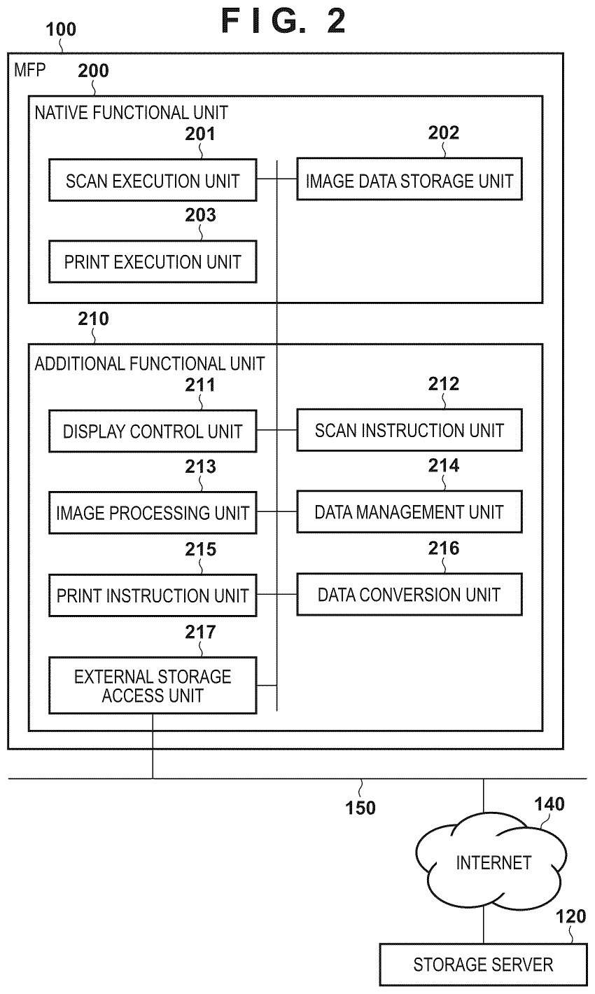

The software configuration of the MFP 100 will now be described with reference to FIG. 2. The MFP 100 may include functional units 201 to 203 and 211 to 217. The MFP 100 may not include one or more of the functional units 201 to 203 and 211 to 217 and may include functional units that are not the functional units 201 to 203 and 211 to 217. The functional units 201 to 203 and 211 to 217 may be implemented by a program read out onto the RAM 104 being executed by the CPU 102. Alternatively, at least one or more of the functional units 201 to 203 and 211 to 217 may be implemented by a dedicated integrated circuit such as an application specific integrated circuit (ASIC). One or more of the functional units 201 to 203 and 211 to 217 may be implemented by a different apparatus disposed on the Internet 140 or on the LAN 150.

The functional units 201 to 203 and 211 to 217 may be divided between a native functional unit 200 and an additional functional unit 210. For example, the native functional unit 200 may include the functional units 201 to 203, and the additional functional unit 210 may include the functional units 211 to 217. The functional units 201 to 203 and 211 to 217 may be divided in a different manner, or all of the functional units may be included in the native functional unit 200. The native functional unit 200 may be a functional unit included as standard in the MFP 100 (for example, a functional unit included at the time of shipping the MFP 100). The additional functional unit 210 may be a functional unit added to the MFP 100 after shipping. For example, the additional functional unit 210 may be able to be implemented by installing an additional application in the MFP 100. An additional application may be an application based on Java (registered trademark).

A display control unit 211 controls the display on the operation unit 111 (for example, a touch screen) of the MFP 100. For example, the display control unit 211 displays a user interface (UI) screen for obtaining instructions from the user on the operation unit 111 of the MFP 100. Hereinafter, the UI screen is simply referred to as the screen. A specific example of the screen displayed on the operation unit 111 will be described below. Unless otherwise mentioned, the screen (that is, the UI screen) obtains instructions from the user.

A scan instruction unit 212 requests a scan execution unit 201 to execute scan processing in accordance with the scan settings input via the UI screen. The scan execution unit 201 receives a scan request including the scan settings from the scan instruction unit 212. The scan execution unit 201 generates image data by reading a document set on a platen glass or set on an ADF with the scanner unit 113 according to the scan request. The image obtained by scanning the document is referred to as the scanned image, and the data representing the scanned image is referred to as scanned image data. The generated scanned image data is sent to an image data storage unit 202. The scan execution unit 201 sends an image identifier uniquely indicating the stored scanned image data to the scan instruction unit 212. The image identifier is a number, symbol, alphabetical character, or the like for uniquely identifying image data such as scanned image data in the MFP 100. The image data storage unit 202 stores the scanned image data received from the scan execution unit 201 in the HDD 105.

An image processing unit 213 executes processing (for example, analysis processing or editing processing) on the scanned image. The image processing unit 213 receives the image identifier from the scan instruction unit 212 and obtains the scanned image data corresponding to the image identifier from the image data storage unit 202. The image processing unit 213 may execute recognition processing on the obtained image data. The recognition processing may include character region recognition, optical character recognition (OCR), barcode region analysis, image rotation and tilt correction, and the like.

The image processing unit 213 may generate a new image by combining a mask image with the scanned image according to mask region settings or the like input via the UI screen. The processing of combining a mask image with an image represented by image data may be referred to as masking processing on image data. The masking processing may be referred to as blacking out. The image generated via the masking processing on the scanned image data is referred to as the mask-combined image data. The scanned image may be an identification document, an application form, a drawing, or the like, and the mask image may be arranged over the personal information or confidential information included in the scanned image. The scanned image may already include a mask image. Even in such cases, another portion of the scanned image may be covered up by the user using a mask image.

Subsequently, the image processing unit 213 may instruct the image data storage unit 202 to store the mask-combined image data. The image processing unit 213, according to the output settings set in the mask-combined image data, sends the image identifier of the mask-combined image data to a printing instruction unit 215, a data conversion unit 216, and an external storage access unit 217.

A data management unit 214 stores information indicating the region where the mask image is arranged and information such as a character string, a file name, a folder name, a storage destination, and the like in association with the image identifier. Also, the data management unit 214 may store this information in the HDD 105 as a preset setting.

The printing instruction unit 215 sends a request for printing processing according to the print settings designated via the screen and the image identifier received from the image processing unit 213 to a print execution unit 203. The print execution unit 203 receives a print request including print settings and an image identifier from the printing instruction unit 215. The print execution unit 203 obtains image data corresponding to the image identifier from the image data storage unit 202 and generates image data for printing according to the print request. The print execution unit 203 prints a mask-combined image on the printing medium with the printer unit 112 according to the generated image data for printing.

The data conversion unit 216 obtains the image data corresponding to the image identifier received from the image processing unit 213 from the image data storage unit 202 and converts the image into a file format according to the output settings designated via the screen. The data conversion unit 216 obtains the file name corresponding to the image identifier received from the image processing unit 213 from the data management unit 214 and sets the file name as the file name of the converted file. The data conversion unit 216 sends the converted file and the corresponding image identifier to the data management unit 214. The data management unit 214 stores the received file in association with the image identifier.

The external storage access unit 217 requests the storage server 120 to store the image data. The external storage access unit 217 uses the interface provided by the storage server 120 to operate the storage service. For example, the external storage access unit 217 obtains the file corresponding to the image identifier received from the image processing unit 213 and the transmitted information from the data management unit 214. The external storage access unit 217 uses the transmitted information obtained from the data management unit 214 to transmit the file obtained from the data management unit 214 to the storage server 120 via the network I/F 110.

### Flow of Operations by MFP

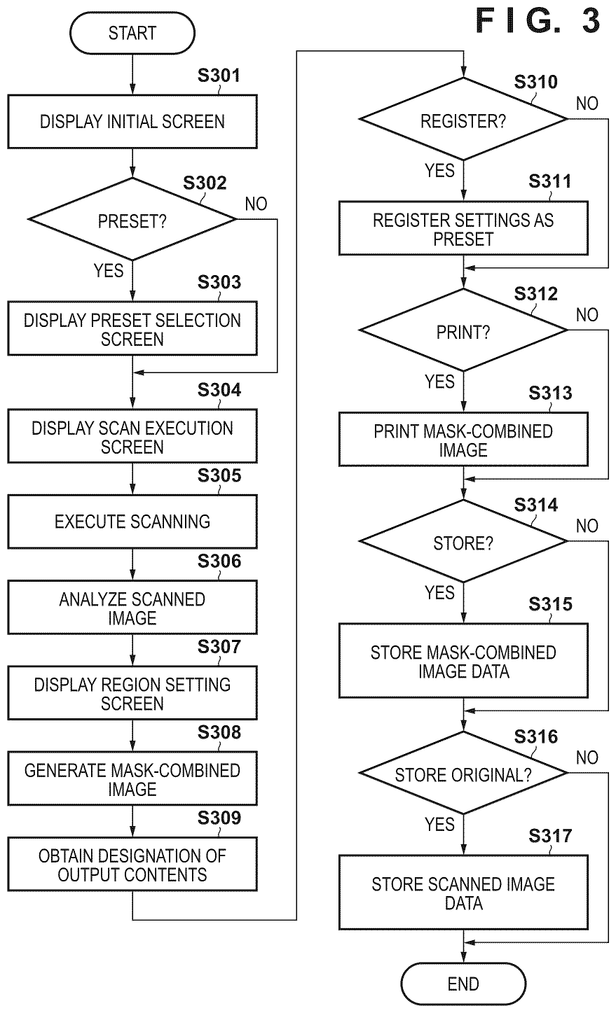

The information processing method executed by the MFP 100 (specifically, the control unit 101) will now be described with reference to FIG. 3. Each step of the method of FIG. 3 may be executed by the CPU 102 reading out and executing a control program stored in the ROM 103 or the HDD 105. The executed control program may be an application additionally installed in the MFP 100. Hereinafter, the application that executes the method of FIG. 3 is referred to as the masking application. The method of FIG. 3 may be started in response to the user selecting the masking application on a main screen displayed on the operation unit 111 (for example, the touch screen) when the MFP 100 is activated and the masking application starting up. At least a portion of the method of FIG. 3 may be executed by a dedicated integrated circuit such as an ASIC instead of the CPU 102.

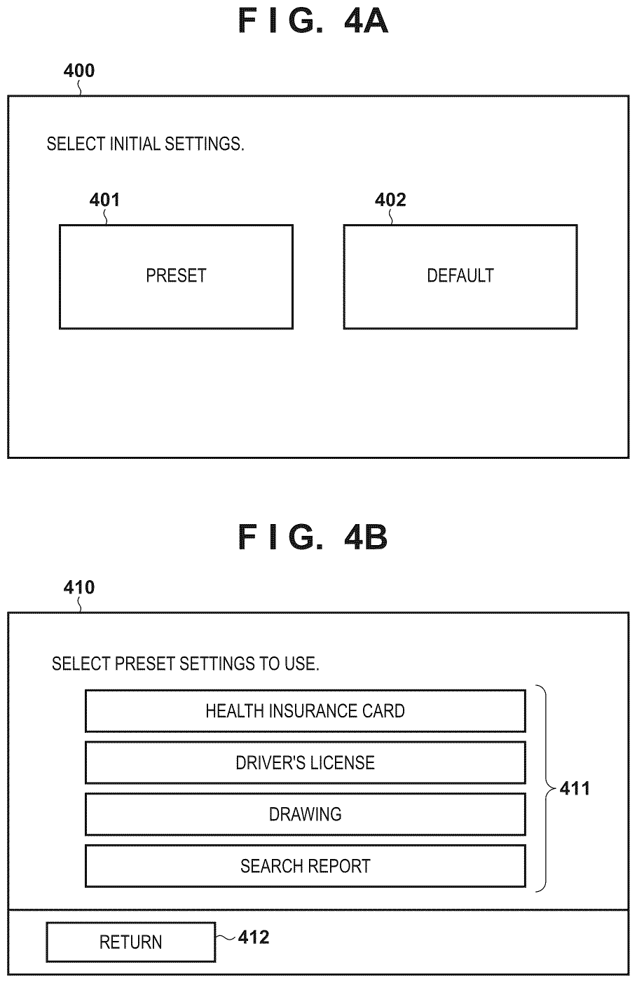

In S301, the MFP 100 displays an initial screen 400 of the masking application on the operation unit 111. The initial screen 400 may be a screen for obtaining the designation of initial settings for the masking application. An example of the initial screen 400 will now be described with reference to FIG. 4A. The initial screen 400 may include objects such as those illustrated in FIG. 4A. An object included on the screen (in other words, the UI screen) may be referred to as a graphic object. The initial screen 400 may include objects not illustrated in FIG. 4A and may not include one or more of the objects illustrated in FIG. 4A. The objects of the initial screen 400 may be substituted for other types of objects that can implement the same functions. The changes that can be made to the initial screen 400 may also be made to the other screens described below. The objects included in each screen described below are single objects unless explicitly described as being a plurality of objects.

A button 401 is an object for obtaining an instruction to display a list of preset settings registered in the MFP 100. A preset may refer to processing for pre-storing settings relating to a scan or mask region, file storage information, and the like in the HDD 105 of the MFP 100 and enabling re-use. The preset settings may be settings that are preset. A button 402 is an object for obtaining an instruction to use the default settings as the initial settings of the masking application. Even in a case where one of these settings are selected as the initial settings, the MFP 100 may allow a user to manually change the settings.

The MFP 100 transitions the processing to S302 in response to either the button 401 or the button 402 on the initial screen 400 being pressed by the user. In S302, the MFP 100 determines whether either the button 401 (preset) or the button 402 (manual) has been pressed by the user. In a case where it is determined that the button 401 has been pressed by the user (“YES” in S302), the MFP 100 transitions the processing to S303. In a case where it is determined that the button 402 has been pressed by the user (“NO” in S302), the MFP 100 transitions the processing to S304.

In S303, the MFP 100 displays a preset selection screen 410 on the operation unit 111. The preset selection screen 410 may be a screen for obtaining a selection of the preset settings. An example of the preset selection screen 410 will now be described with reference to FIG. 4B. A list 411 is an object for obtaining the settings of the preset settings. The list 411 includes one or more buttons for obtaining the settings for each of the one or more preset settings registered in the masking application. The preset settings registered in the masking application may be settings registered by the user when previously executing the method of FIG. 3 or may be settings included in the masking application from the start.

In response to one of the buttons included in the list 411 being pressed by the user, the MFP 100 reads out the preset settings associated with the button from the HDD 105 and stores the preset settings in the RAM 104 for the subsequent processing. Each preset setting may be allocated with a unique preset ID. Each button included in the list 411 may be associated with a preset ID. Alternatively, a button ID uniquely allocated to each button included in the list 411 may be associated with preset settings. For example, in response to a button labelled “health insurance card” being pressed by the user, the MFP 100 reads out the preset settings associated with the button. After the MFP 100 has read out the preset settings, the processing transitions to S304.

A button 412 is an object for obtaining an instruction to return to the initial screen 400. In response to the button 412 being pressed by the user, the MFP 100 may display the initial screen 400 again and transition the processing to S301.

In S304, the MFP 100 displays a scan execution screen 500 on the operation unit 111. The scan execution screen 500 may be a screen for obtaining an instruction to start scanning. On the scan execution screen 500, settings relating to scanning may be obtained. In a case where the preset settings are read out to the RAM 104 in S303, the MFP 100 may display the scan execution screen 500 with the preset settings applied. In a case where “default” is selected on the initial screen 400 displayed in S302, the MFP 100 may display the scan execution screen 500 using the default settings.

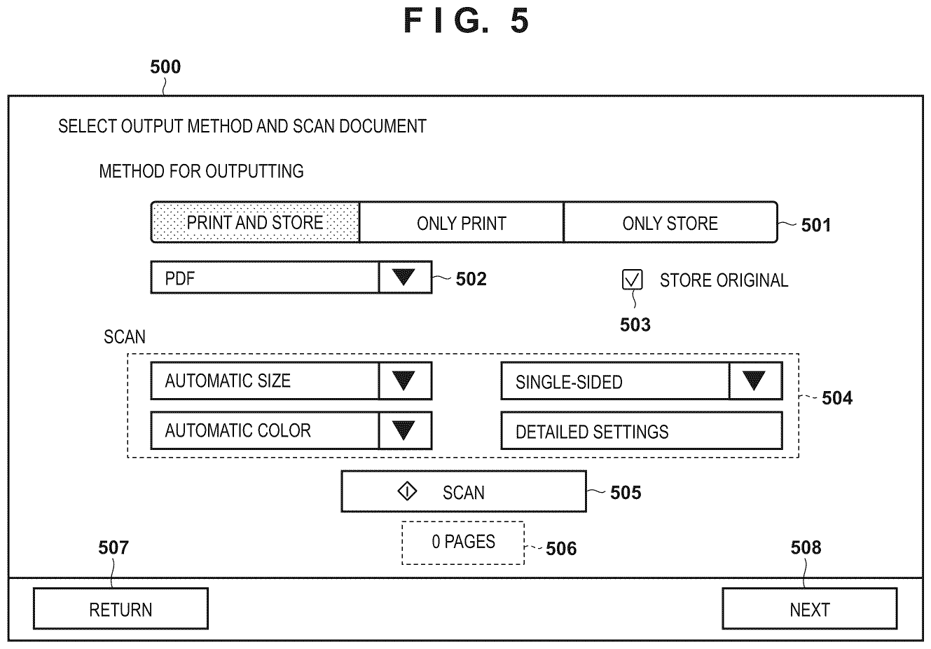

An example of the scan execution screen 500 will now be described with reference to FIG. 5. An output settings object 501 is an object for obtaining the designation of a method for outputting a mask-combined image. The output settings object 501 may include a plurality of buttons that can be exclusively selected. In the example of FIG. 5, the output settings object 501 includes a button for obtaining a designation to execute both print and store, a button for obtaining a designation to only execute print, and a button for obtaining a designation to only execute store. A pull-down list 502 is an object for obtaining the designation of a file format for when storing the mask-combined image data. The pull-down list 502 may only be enabled when “print and store” and “only store” are selected in the output settings object 501.

A check button 503 is an object for obtaining a designation of whether or not to store the scanned image data (in other words, the pre-masking-processing image data). In FIG. 5, the scanned image is referred to as “original”. The same applies for the other diagrams described below. In a case where the check button 503 is in a checked state (in other words, is checked), the scanned image data is stored in the subsequent processing. On the other hand, in a case where the check button 503 is not in a checked state (in other words, is not checked), the scanned image data is not stored in the subsequent processing.

A scan settings object 504 is an object for obtaining a designation of the scan settings for the document. In the example of FIG. 5, the scan settings object 504 includes a pull-down list for obtaining a designation of the document size, a pull-down list for obtaining a designation of the surface to be scanned, and a pull-down list for obtaining a designation of the color settings. The scan settings object 504 further includes a button for obtaining an instruction to set detailed settings. In the detailed settings, a designation for resolution, image quality, mixed document size, density, and the like.

A scan start button 505 is an object for obtaining an instruction to start scanning a document. A display field 506 is an object for displaying the number of pages that have been scanned. A button 507 is an object for obtaining an instruction to return to the previous screen (for example, the initial screen 400 or the preset selection screen 410). A button 508 is an object for obtaining an instruction to advance to the next screen.

In response to the scan start button 505 of the scan execution screen 500 being pressed by the user, the MFP 100 transitions the processing to S305. In S305, the MFP 100 starts scanning a document placed on the platen glass or a document set on the ADF of the MFP 100 by the user. Specifically, the MFP 100 generates image data by digitizing the document. As described above, the image data may be referred to as scanned image data. The MFP 100 further generates an image identifier that uniquely indicates the scanned image data. The MFP 100 associates together the scanned image data and the image identifier and stores them in the HDD 105. Each time the equivalent of one page of a scanned image is generated, the MFP 100 increases the page number displayed in the display field 506 by one.

After scanning of the document is complete, the MFP 100 transitions the processing to S306 in response to the button 508 of the scan execution screen 500 being pressed by the user. In S306, the MFP 100 analyzes the scanned image. For example, the MFP 100 may extract a character region that exists in the scanned image and may identify the coordinates of the character region and the characters in the character region. The MFP 100 associates the analysis result with the image identifier and stores them in the HDD 105.

In response to the completion of the analysis of S306, in S307, the MFP 100 displays a region setting screen 600 on the operation unit 111. The region setting screen 600 may be a screen for obtaining the setting of the mask region. The setting of the mask region may be executed may any method including setting based on a coordinate position, setting based on a character string, setting based on an attribute, and the like. Hereinafter, an example where the mask region is set on the basis of a coordinate position will be described. In a case where the preset settings are read out to the RAM 104 in S303, the MFP 100 may display the region setting screen 600 with the preset settings applied. In a case where “default” is selected on the initial screen 400 displayed in S302, the MFP 100 may display the region setting screen 600 using the default settings.

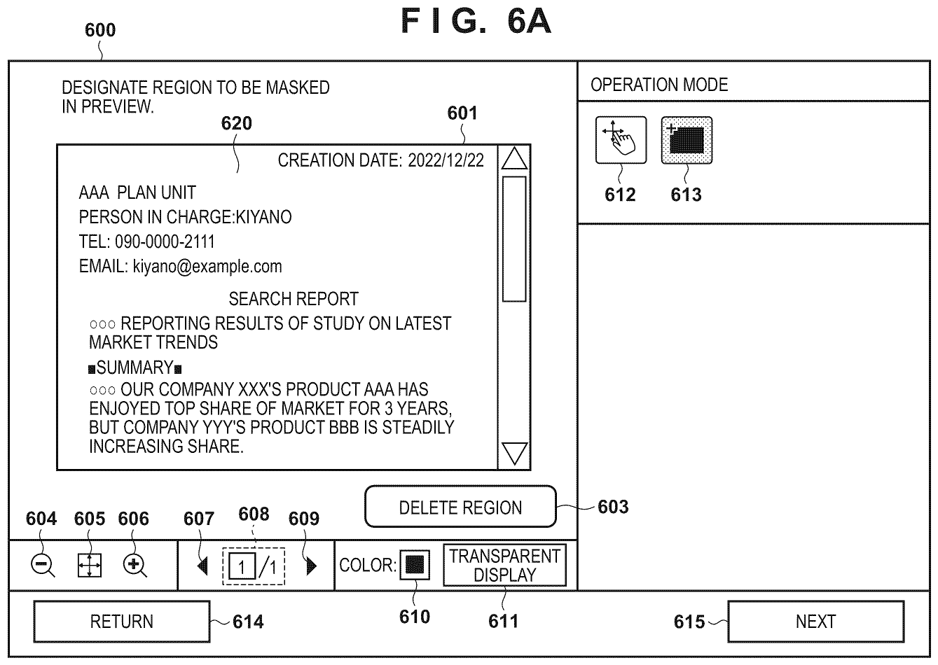

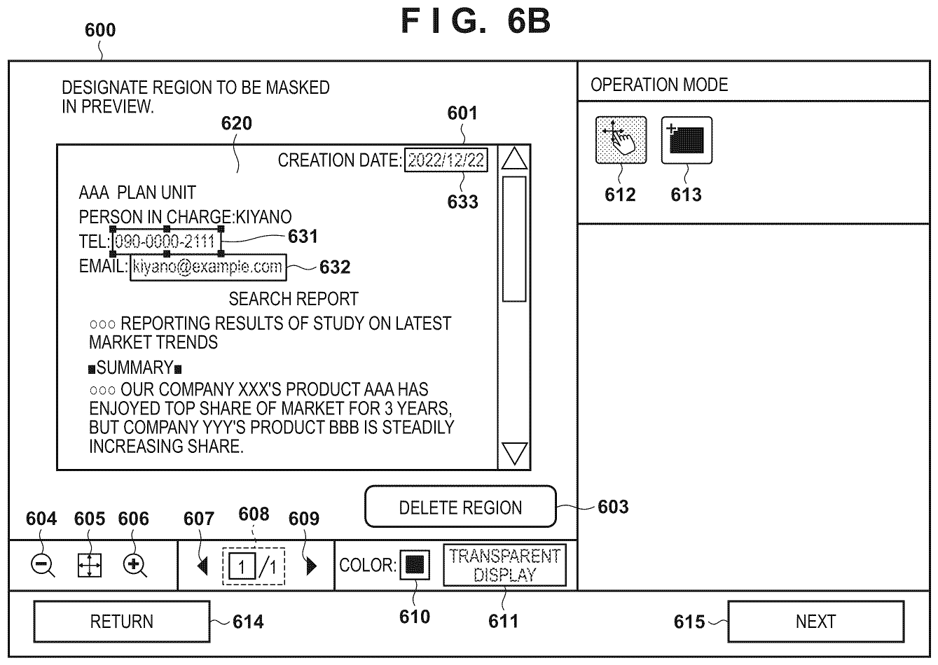

An example of the region setting screen 600 will now be described with reference to FIG. 6A. A display field 601 is an object for displaying a preview image 620 of the scanned image generated in S305. In a case where the preview image 620 does not fit into the display field 601, the MFP 100 may display a scrollbar next to the display field 601. A button 603 is an object for obtaining an instruction to delete the currently selected mask region on the preview image 620.

An icon 604 is an object for obtaining an instruction to decrease the display magnification of the preview image 620 by a predetermined amount. The icon 604 is an object for obtaining an instruction to display the entire preview image 620 in the display field 601 at maximum size. An icon 606 is an object for obtaining an instruction to increase the display magnification of the preview image 620 by a predetermined amount.

An icon 607 is an object for obtaining an instruction to display the scanned image of one page previous in the display field 601 in a case where the scanned image includes a plurality of pages. A display field 608 is an object for displaying the page number and total page number of the scanned image currently displayed in the display field 601. An icon 609 is an object for obtaining an instruction to display the scanned image of one page forward in the display field 601 in a case where the scanned image includes a plurality of pages.

A button 610 is an object for obtaining a designation of the color of the mask region. The designation of the color of the mask region may be the designation of a single color used to conceal the mask region or may include a concealment result, such as a mosaic or stamp. A toggle button 611 is an object for obtaining a designation of whether or not to display the mask region of the preview image 620 in a semitransparent state. In a case where the toggle button 611 is on, the MFP 100 displays the mask region in a semitransparent state so that the user can visually inspect the portion (for example, character string) under the mask region. In a case where the toggle button 611 is off, the MFP 100 displays the mask region in a nontransparent state so that the user cannot visually inspect the portion under the mask region.

A toggle button 612 is an object for obtaining an instruction to transition to a mode for changing the mask region displayed on the preview image 620. A toggle button 613 is an object for obtaining an instruction to transition to a mode for adding a new mask region displayed on the preview image 620. The toggle button 612 and the toggle button 613 may be exclusively selectable.

Setting the mask region may be performed by the user using a finger and touching inside the display field 601. For example, in response to the operation unit 111 detecting a touch inside the display field 601, the MFP 100 starts drawing a rectangle with a start point at the touched location. Thereafter, in response to the operation unit 111 detecting a touch release (lift off) inside the display field 601, the MFP 100 sets the end point of the rectangle to the touch-release position. The user can freely change the touch position in the time between the touch and the touch release. The MFP 100 displays the rectangle with corners at the start point and the end point designated by the user. The rectangle is displayed in a color designated using the button 610. The MFP 100 stores the start point, the end point, and the color designated by the user in association with one another. The region to be masked by the touch operation may be a character string or may be a barcode, photo, or similar region.

A button 614 is an object for obtaining an instruction to return to the previous screen (for example, the scan execution screen 500). A button 615 is an object for obtaining an instruction to advance to the next screen.

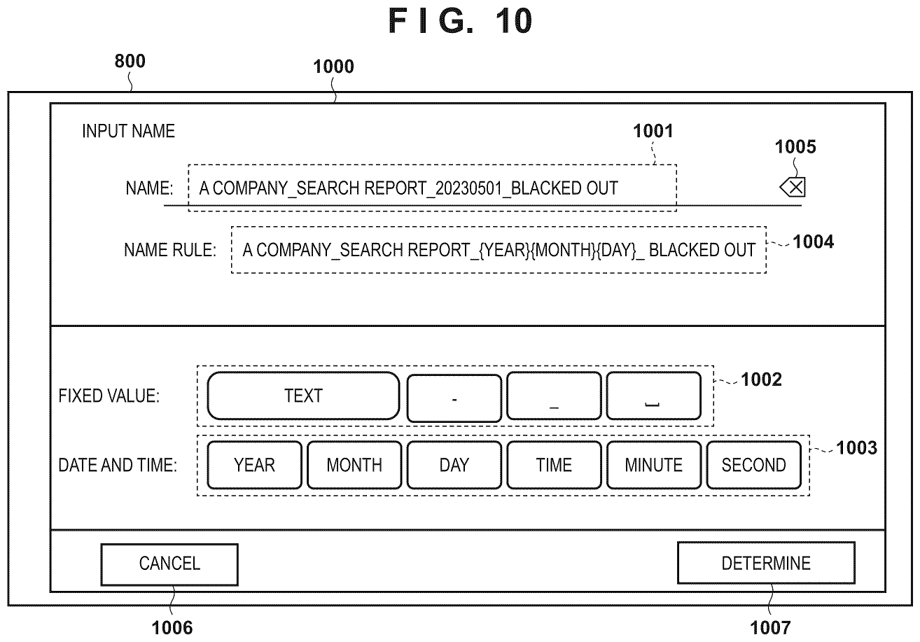

FIG. 10B is a diagram for describing an example of the region setting screen 600 after three mask regions 631 to 633 are set on the display field 601 by the user. Since the toggle button 611 is on, the mask regions 631 to 633 are displayed in a semitransparent state. When the toggle button 611 is off, the mask regions 631 to 633 are displayed in a nontransparent state in the color designated using the button 610.

In the region setting screen 600 of FIG. 6B, since the toggle button 612 is selected, the MFP 100 operates in a mode for changing the mask region displayed on the preview image 620. In FIG. 6B, the mask region 631 is selected as the change target. The currently selected mask region 631 may be displayed in an emphasized state by being displayed with a thick frame or the like. Also, so that the user can recognize that the mask region 631 can be changed, a rectangle icon is displayed at the center of each side and each corner of the mask region 631. The user can adjust the position of the mask region 631 by dragging and moving the rectangle icons. When the user drags and moves a rectangle icon, the point or line displayed by the rectangle icon on the diagonal line becomes a start point, and the mask region 631 is expand or reduced in the movement direction from there. In a case where the user drags a position of the mask region 631 other than these, the mask region 631 moves while retaining its size.

In a case where one of the mask regions is selected, the MFP 100 may make the button 603 operable. For example, in response to the button 603 being pressed by the user with the mask region 631 in a selected state, the MFP 100 deletes the mask region 631 from the display field 601.

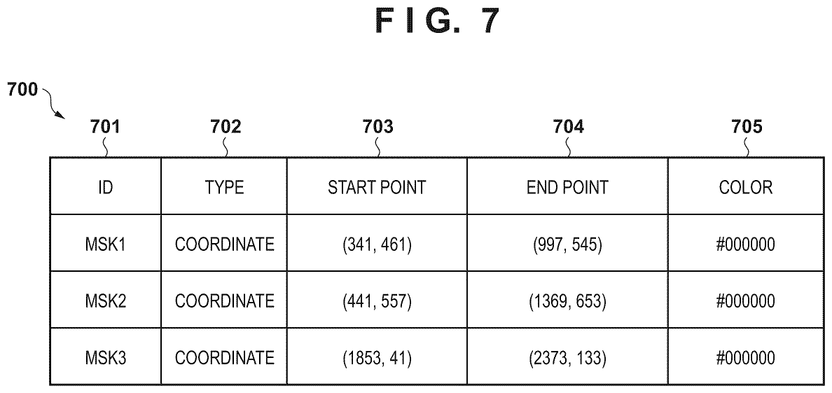

An example of region information 700 relating to a mask region set for the scanned image will now be described with reference to FIG. 7. In FIG. 7, the region information 700 is represented in a table format. Alternatively, a different format may be used to represent the region information 700. The region information 700 may be stored in the RAM 104 in association with the scanned image. The region information 700 includes a record for each mask region set in the scanned image.

A column 701 stores an identifier for uniquely identifying a mask region. A column 702 stores the type of method used to designate the position of the mask region. The column 702 may include a value such as “coordinates”, “text”, “attribute”, or the like, for example. A column 703 stores the coordinate values of the start point of the mask region. The coordinate values are represented in the format of “horizontal coordinate value, vertical coordinate value), with the top left corner of the scanned image corresponding to the origin. A column 704 stores the coordinate values of the end point of the mask region. The rectangle formed by the opposing corners corresponding to the point represented by the column 703 and the point represented by the column 704 is the mask region. A column 705 stores the RGB value of the color designated for the mask region.

In the case of the user adding a mask region or when the preset information is read out, the MFP 100 adds a record to the region information 700 for the current scanned image data. In a case where the mask region has been changed by the user, the MFP 100 updates the record corresponding to the mask region. In a case where the mask region has been deleted by the user, the MFP 100 deletes the record corresponding to the mask region.

In response to the button 615 being pressed by the user on the region setting screen 600, the MFP 100 transitions the processing to S308. In S308, the MFP 100 generates a mask-combined image by superimposing one or more mask regions set in the region information 700 on the scanned image and storing the mask-combined image data in the HDD 105. The MFP 100 further associates the region information 700 used to generate the mask-combined image with the image identifier of the scanned image data and stores these in the HDD 105.

In response to the completion of the generation and storage of the mask-combined image data, in S309, the MFP 100 obtains a designation of the output contents. First, the MFP 100 displays an output confirmation screen 800 on the operation unit 111. The output confirmation screen 800 may be a screen for presenting to the user the current output contents of the output image data and obtaining a designation of the output contents from the user. The output confirmation screen 800 may obtain an instruction to change the output contents from the user. The output image data corresponds to the scanned image data and the mask-combined image data in a case where the user has instructed for the storage of the scanned image data and corresponds to the mask-combined image data in a case where the user has not instructed for the storage of the scanned image data. In a case where the preset settings are read out to the RAM 104 in S303, the MFP 100 may display the output confirmation screen 800 with the preset settings applied. In a case where “default” is selected on the initial screen 400 displayed in S302, the MFP 100 may display the output confirmation screen 800 using the default settings.

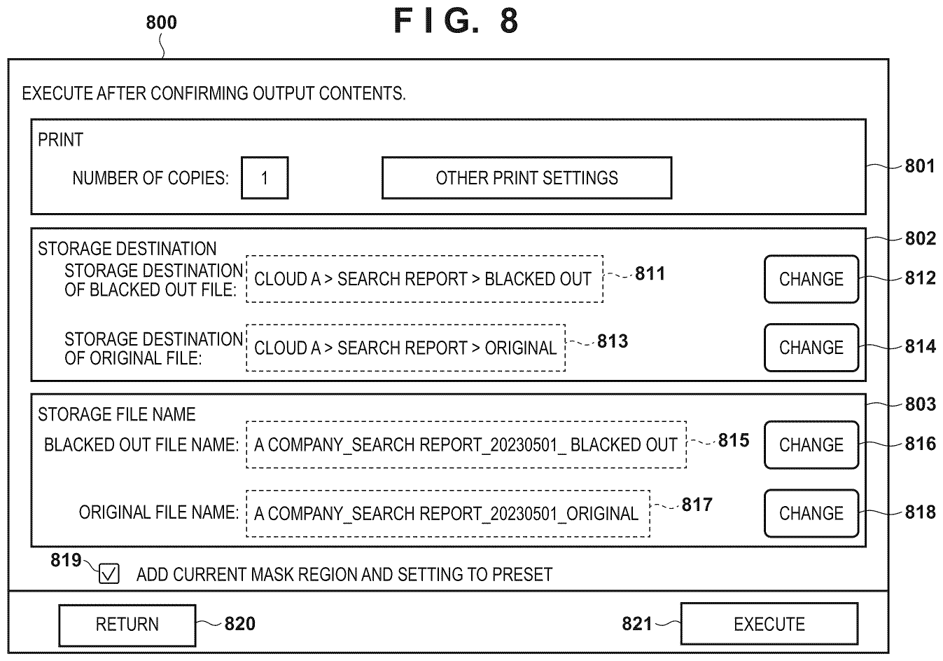

An example of the output confirmation screen 800 will now be described with reference to FIG. 8. A display area 801 includes an object relating to printing. The display area 801 may be displayed only in a case where print has been designated as the output method by the user. In the example of FIG. 8, the display area 801 includes a display field for obtaining a designation of the number of copies to print and a button for obtaining an instruction to display the screen for other print settings (for example, double-sided, sheet size, imposition, and the like).

A folder designation area 802 includes an object for confirming and changing the storage destination of the output image data. The folder designation area 802 may be displayed only in a case where store has been designated as the output method by the user. In the example of FIG. 8, the folder designation area 802 includes a display field 811 indicating the storage destination currently set for the mask-combined image data (“blacked out file” in FIG. 8) and a change button 812 for obtaining an instruction to change the storage destination. Also, the folder designation area 802 includes a display field 813 indicating the storage destination currently set for the scanned image data (“original file” in FIG. 8) and a change button 814 for obtaining an instruction to change the storage destination. The objects 813 and 814 relating to the scanned image data may be displayed only in a case where storage of the scanned image data has been instructed by the user. In this manner, the MFP 100 can separately obtain a designation of the storage destination of the scanned image data and a designation of the storage destination of the mask-combined image data from the user using the output confirmation screen 800.

The storage destination of the image data may be specified by a name (in other words, a storage service name) of a storage service that provides a storage area and a folder path. To make the storage destination easily recognizable for the user, the MFP 100 may display the folder path after the storage service name as illustrated in FIG. 8. For example, as displayed in the display field 811 of FIG. 8, the currently set storage service name is “cloud A”, and the currently set folder path is “search report>black out”. This may also apply to the display of the storage destination in other screens.

A file name designation area 803 includes an object for confirming and changing the file name of the output image data. The file name designation area 803 may be displayed only in a case where store has been designated as the output method by the user. In the example of FIG. 8, the file name designation area 803 includes a display field 815 indicating the file name currently set for the mask-combined image data and a change button 816 for obtaining an instruction to change the file name. Also, the file name designation area 803 includes a display field 817 indicating the file name currently set for the scanned image data and a change button 818 for obtaining an instruction to change the file name. These objects relating to the scanned image data may be displayed only in a case where storage of the scanned image data has been instructed by the user. In this manner, the MFP 100 can separately obtain a designation of the file name of the scanned image data and a designation of the file name of the mask-combined image data from the user using the output confirmation screen 800.

A check button 819 is an object for obtaining an instruction to register the settings (for example, mask region and storage destination) in the current processing as a preset setting. A button 820 is an object for obtaining an instruction to return to the previous screen (for example, the region setting screen 600). A button 821 is an object for obtaining an instruction to start the output (print, store, or both) of the output image data.

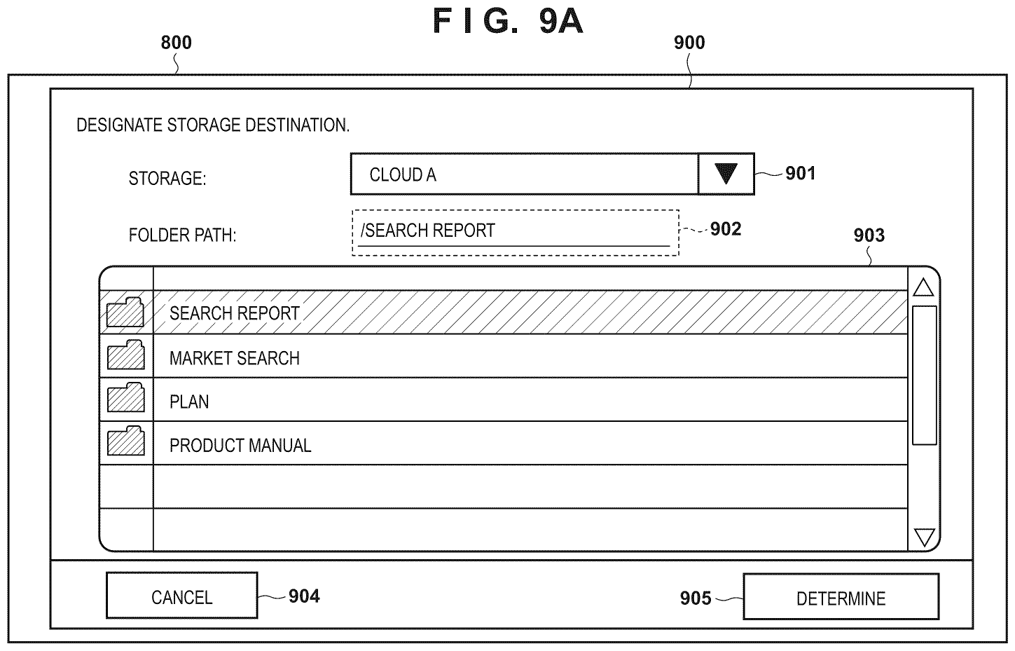

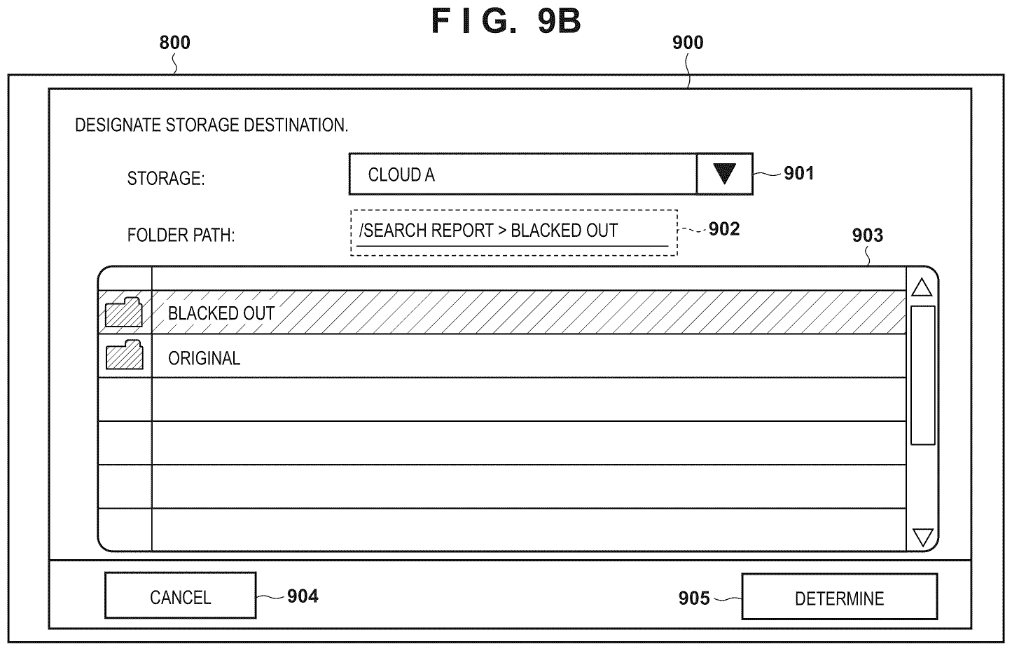

In response to the change button 812 being pressed by the user on the output confirmation screen 800, the MFP 100 displays a storage destination settings screen 900 on the operation unit 111. The MFP 100 may display the storage destination settings screen 900 layered on top of the output confirmation screen 800. An example of the storage destination settings screen 900 will now be described with reference to FIG. 9A.

A pull-down list 901 is an object for obtaining the designation of a storage service for storing the combined image data. The storage service included in the currently set storage destination at the point in time when the storage destination settings screen 900 is displayed is set as the initial value of the pull-down list 901 by the MFP 100. In the example of FIG. 9A, “cloud A” is selected. In response to a specific storage service being selected from the pull-down list 901, the MFP 100 starts connecting to the selected storage service. In a case where user authentication is required to use the storage service, the MFP 100 may display a screen (not illustrated) for obtaining authentication information from the user and may transmit the authentication information obtained from the user to the storage service. In response to the storage service becoming usable, the MFP 100 displays a list 903 of folders that can be used in the storage service. A display field 902 is an object for displaying a folder path designated by the user. The folder path included in the currently set storage destination at the point in time when the storage destination settings screen 900 is displayed is set as the initial value of the display field 902 by the MFP 100. In the example of FIG. 9A, “search report” folder is selected.

The list 903 is an object for displaying one or more folders that can be used in the currently selected storage service from the pull-down list 901 and obtaining a selection of a folder. In response to one of the one or more folders displayed in the list 903 being selected by the user, the MFP 100 changes the folder path designated by the display field 902.

In a case where the currently selected folder includes a lower-level folder, the MFP 100 changes the list 903 to display the lower-level folder in response to the folder in the list 903 being double-clicked or long-pressed. For example, in a case where the “search report” folder of the list 903 includes a lower-level folder, the MFP 100 changes to display the list 903 as illustrated in FIG. 9B in response to the “search report” folder being double-clicked or long-pressed. In the illustrated example, the “search report” folder include a “blacked out” folder and an “original” folder. Also, in the example illustrated in FIG. 9B, the “blacked out” folder is selected. Thus, the display of the display field 902 is changed to “search report>black out”. In this manner, the user change discretionarily change the output destination of the output image data using the storage destination settings screen 900.

A button 904 is an object for obtaining an instruction to discard the settings designated on the storage destination settings screen 900, close the storage destination settings screen 900, and display the output confirmation screen 800. A button 905 is an object for obtaining an instruction to apply the settings designated on the storage destination settings screen 900. In response to the button 905 being pressed by the user, the MFP 100 closes the storage destination settings screen 900 and displays the output confirmation screen 800. The MFP 100 changes the storage destination currently set for the mask-combined image data to a combination of storage service currently selected in the pull-down list 901 and the folder path designated in the display field 902. The MFP 100 changes the display of the display field 811 to the new storage destination.

In response to the change button 814 being pressed by the user on the output confirmation screen 800, the MFP 100 displays a storage destination settings screen 900 on the operation unit 111. The operation of the storage destination settings screen 900 when the change button 814 is pressed is similar to the operation described above of the storage destination settings screen 900 when the change button 812 is pressed. In response to the button 905 being pressed by the user, the MFP 100 closes the storage destination settings screen 900 and displays the output confirmation screen 800. The MFP 100 changes the storage destination currently set for the scanned image data to a combination of storage service currently selected in the pull-down list 901 and the folder path designated in the display field 902. The MFP 100 changes the display of the display field 813 to the new storage destination.

In response to the change button 816 being pressed by the user on the output confirmation screen 800, the MFP 100 displays a name settings screen 1000 on the operation unit 111. The MFP 100 may display the name settings screen 1000 layered on top of the output confirmation screen 800. An example of the name settings screen 1000 will now be described with reference to FIG. 10.

A display field 1001 is an object for displaying the currently set name. An object 1002 is an object for obtaining a designation of a fixed character string to add to the end of the name displayed in the display field 1001. The fixed character string may be a character string independent of the context at the time of input by the user. For example, in response to a button labelled “text” being pressed by the user, the MFP 100 displays a keyboard (not illustrated) for inputting text and obtains an input of any character string from the user. Thereafter, the MFP 100 adds a character string to the end of the name displayed in the display field 1001. In response to a button labelled delimiter character (hyphen, underscore, blank, and the like) being pressed by the user, the MFP 100 adds the delimiter character to the end of the name displayed in the display field 1001.

The object 1002 is an object for obtaining a designation of a variable character string to add to the end of the name displayed in the display field 1001. The variable character string may be a character string dependent of the context at the time of input by the user. In the example of FIG. 10, a character string representing the date and time is used as the variable character string. Instead of or in addition to, the variable character string may include another character string, a user name for logging into the storage service, or the like.

In response to buttons labelled units relating to time (year, month, day, hour, minute, second, and the like) being pressed by the user, the MFP 100 determines the character string corresponding to these units on the basis of the context at the time of input by the user. Thereafter, the MFP 100 adds the determined character string to the end of the name displayed in the display field 1001. The context at the time of input by the user may be the date and time when the scan is executed in S305 or may be the date and time when buttons included in the object 1003 are pressed. By providing the object 1003, the user can easily input date and time information in the name.

A display field 1004 is an object for displaying the type of button from among the objects 1002 and 1003 used by the user to set the name. The text displayed in the display field 1004 is used to determine the name and thus may be referred to as the name rule. In response to a button included in the object 1002 being pressed by the user, the MFP 100 adds the character string added to the end of the name displayed in the display field 1001 also to the end of the rule displayed in the display field 1004. In response to a button included in the object 1003 being pressed by the user, the MFP 100 adds the character string representing the type of button pressed to the end of the name rule displayed in the display field 1004. The character string representing the type of button pressed may be referred to as a variable name. In a case where the button labelled “year” is pressed by the user, for example, the MFP 100 adds “{year}” to the end of the name rule displayed on the display field 1004. By displaying the character string (variable name) representing the type of button in this manner, the user can easily see that the name has been set using a variable character string.

A button 1005 is an object for obtaining an instruction to delete the character string of the name displayed in the display field 1001 from the end. In a case where the character string of the end of the name in the display field 1001 is a fixed character string, the MFP 100 deletes one character at the end of the name in the display field 1001 in response to the button 1005 being pressed. Also, the MFP 100 deletes one character of the end of the name rule in the display field 1004 in conjunction with the deletion of one character of the end of the name.

In a case where the character string of the end of the name in the display field 1001 is a variable character string, the MFP 100 deletes the entire variable character string at the end of the name in the display field 1001 in response to the button 1005 being pressed. For example, in a case where “05” has been added by the button labelled “day” being pressed, the MFP 100 deletes the entire two characters “05” from the end of the name. Also, the MFP 100 deletes the variable name of the end of the name rule in the display field 1004 in conjunction with the deletion of one character of the end of the name. In a case where “{day}” has been added by the button labelled “day” being pressed, the MFP 100 deletes the entire three characters “{day}” from the end of the name.

A button 1006 is an object for obtaining an instruction to discard the settings designated on the name settings screen 1000, close the name settings screen 1000, and display the output confirmation screen 800. A button 1007 is an object for obtaining an instruction to apply the settings designated on the name settings screen 1000. In response to the button 1007 being pressed by the user, the MFP 100 closes the name settings screen 1000 and displays the output confirmation screen 800. The MFP 100 changes the file name currently set for the mask-combined image data to the name designated in the display field 1001. The MFP 100 changes the display of the display field 815 to the new file name.

In response to the change button 818 being pressed by the user on the output confirmation screen 800, the MFP 100 displays a name settings screen 1000 on the operation unit 111. The operation of the name settings screen 1000 when the change button 818 is pressed is similar to the operation described above of the name settings screen 1000 when the change button 816 is pressed. In response to the button 1007 being pressed by the user, the MFP 100 closes the name settings screen 1000 and displays the output confirmation screen 800. The MFP 100 changes the file name currently set for the scanned image data to the name designated in the display field 1001. The MFP 100 changes the display of the display field 817 to the new file name.

Returning to FIG. 3, in response to the button 821 being pressed by the user on the output confirmation screen 800, the MFP 100 transitions the processing to S310. In S310, the MFP 100 determines whether or not there has been an instruction to register the current settings as a preset setting. The current settings may be the settings designated by the user in S301 to S309. The settings designated by the user may include both the settings unchanged from the initial values and the settings changed by the user. In a case where it is determined that there has been an instruction to register the current settings as a preset setting (“YES” in S310), the MFP 100 transitions the processing to S311. Otherwise (“NO” in S310), the MFP 100 transitions the processing to S312. The determination may be executed on the basis of whether or not the check button 819 of the output confirmation screen 800 is in a checked state.

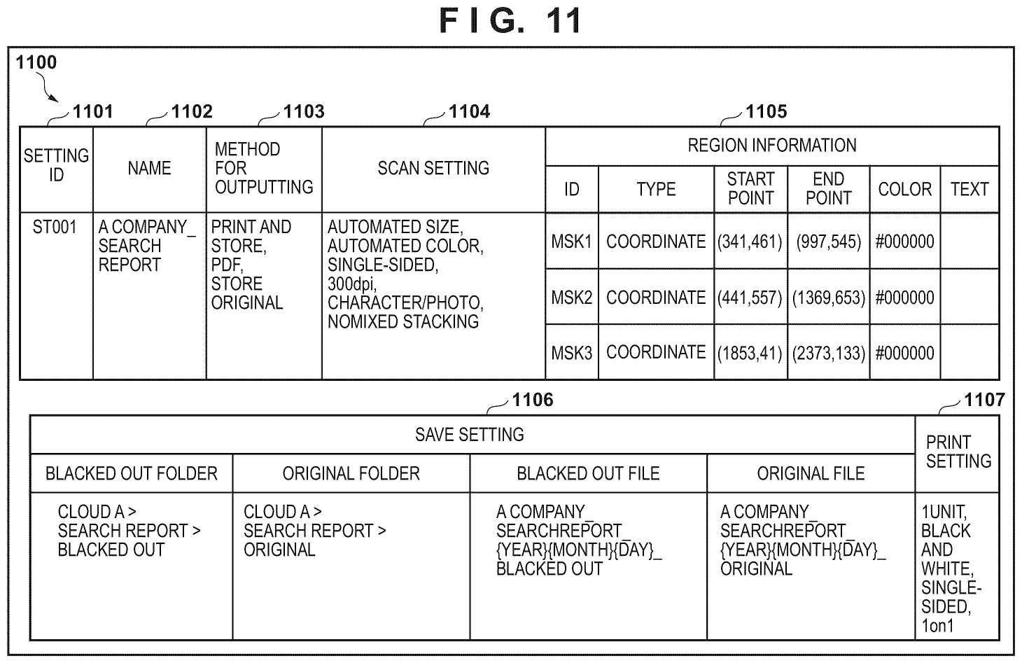

In S311, the MFP 100 registers the current settings as a preset setting. For example, the MFP 100 stores preset information 1100 including the current settings in the HDD 105. An example of the preset information 1100 will now be described with reference to FIG. 11. In FIG. 11, the preset information 1100 is represented in a table format. Alternatively, a different format may be used to represent the preset information 1100. The preset information 1100 includes a record for each preset setting. In FIG. 11, each record is split into two rows.

A column 1101 stores an identifier (preset ID) for uniquely identifying the preset setting. The preset ID may be a number, symbol, alphabetical character, or the like for uniquely identifying the preset setting. The MFP 100 may generate a new identifier each time S310 is executed. A column 1102 stores a name for the preset setting. The value of the column 1102 may be displayed on the button for the preset selection screen 410. The MFP 100 may display a screen (not illustrated) for obtaining the name of the preset setting on the operation unit 111 and may obtain a name from the user via this screen.

A column 1103 stores the method for outputting the image data. The MFP 100 stores the settings designated by the output settings object 501, the pull-down list 502, and the check button 503 of the scan execution screen 500 in the column 1103. For example, in a case where the check button 503 is in a checked state, the column 1103 includes the character string “store original”.

A column 1104 stores the scan settings. The MFP 100 stores the settings designated by the scan settings object 504 of the scan execution screen 500 in the column 1104. A column 1105 stores information relating to the mask region. The MFP 100 stores information relating to the mask region designated on the region setting screen 600 in the column 1105.

A column 1106 stores the settings relating to storing the output image data. The column 1106 may include the storage destination and file name of the mask-combined image data and the storage destination and file name of the scanned image data. The column 1106 may include the name rule designated in the display field 1004 of the name settings screen 1000 instead of the file name. In a case where the preset setting including the name rule of the file name is used in the subsequent method of FIG. 3, the MFP 100 may determine the file name following the name rule on the basis of the context at this point in time and may use it as the initial value. For example, the MFP 100 may convert the variable character string included in the name rule into the date and time when scanning was executed in a new processing.

A column 1107 stores the settings relating to printing. The MFP 100 stores the print settings designated on the output confirmation screen 800 in the column 1107.

The MFP 100 stores the settings included in the preset information 1100.

In S312, the MFP 100 determines whether or not there has been an instruction to print the mask-combined image. In a case where it is determined that there has been an instruction to print the mask-combined image (“YES” in S312), the MFP 100 transitions the processing to S313. Otherwise (“NO” in S312), the MFP 100 transitions the processing to S314. The determination may be executed on the basis of the selection in the output settings object 501 of the scan execution screen 500. In S313, the MFP 100 prints the mask-combined image.

In S314, the MFP 100 determines whether or not there has been an instruction to store the mask-combined image data. In a case where it is determined that there has been an instruction to store the mask-combined image data (“YES” in S314), the MFP 100 transitions the processing to S315. Otherwise (“NO” in S314), the MFP 100 transitions the processing to S316. The determination may be executed on the basis of the selection in the output settings object 501 of the scan execution screen 500.

In S315, the MFP 100 stores the mask-combined image data at the storage destination designated by the user. For example, first, the MFP 100 converts the mask-combined image data to the file format designated in the pull-down list 502 of the scan execution screen 500. Thereafter, the MFP 100 stores the mask-combined image data under the file name designated in the display field 815 of the output confirmation screen 800 at the storage destination designated in the display field 811 of the output confirmation screen 800. Specifically, the MFP 100 requests the storage server 120 providing the storage service designated as the storage destination to store the mask-combined image data under the file name designated by the user at the folder path designated by the user. The storage server 120 stores the mask-combined image data according to the request.

In S316, the MFP 100 determines whether or not there has been an instruction to store the scanned image data. In a case where it is determined that there has been an instruction to store the scanned image data (“YES” in S316), the MFP 100 transitions the processing to S317. Otherwise (“NO” in S316), the MFP 100 ends the processing. The determination may be executed on the basis of whether or not the check button 503 of the scan execution screen 500 is in a checked state.

In S317, the MFP 100 stores the scanned image data at the storage destination designated by the user. For example, first, the MFP 100 converts the scanned image data to the file format designated in the pull-down list 502 of the scan execution screen 500. Thereafter, the MFP 100 stores the scanned image data under the file name designated in the display field 817 of the output confirmation screen 800 at the storage destination designated in the display field 813 of the output confirmation screen 800. Specifically, the MFP 100 requests the storage server 120 providing the storage service designated as the storage destination to store the scanned image data under the file name designated by the user at the folder path designated by the user. The storage server 120 stores the scanned image data according to the request.

Thereafter, the MFP 100 ends the processing. After the end of the processing of FIG. 3, the masking application may be ended and the main screen of the MFP 100 displayed by the MFP 100, or the processing may return to S301 and the initial screen 400 may be displayed by the MFP 100.

The order in which S310, S312, S314, and S316 are executed is not limited to the order in the example described above. The steps may be executed in a different order or in parallel. S310, S312, S314, and S316 are executed in response to the button 821 on an output confirmation screen 1200 being pressed by the user. Thus, in a case where both storage of the mask-combined image data and storage of the scanned image data are instructed by the user, the MFP 100 starts both the storage of the mask-combined image data and the storage of the scanned image data in response to a single instruction from the user, namely the button 821 being pressed.

In the method of FIG. 3, the user may issue an instruction to store the mask-combined image data and the scanned image data in the same folder. In a case where such an instruction is obtained, the MFP 100 stores the mask-combined image data and the scanned image data in the same folder. For example, in a case where access privileges are set for the designated folder and it is determined that there is no security risk, the user may issue such an instruction. Alternatively, the user may issue an instruction to store the mask-combined image data and the scanned image data in separate folders. In a case where such an instruction is obtained, the MFP 100 stores the mask-combined image data and the scanned image data in separate folders.

In the method of FIG. 3, the scanned image data is used as the pre-masking-processing image data. The pre-masking-processing image data may not be image data generated by scanning. For example, the MFP 100 may receive the image data from another apparatus and may execute masking processing on the image data.

In the example described above, each step of the method of FIG. 3 may be execute by an information processing apparatus (in other words, the control unit 101) not included in the MFP 100. Alternatively, one or more of the steps (for example, S307 to S309 and S314 to S317) of the method of FIG. 3 may be executed by an information processing apparatus not included in the MFP 100.

According to the first embodiment, a designation of the storage destination of the mask-combined image data and a designation of the storage destination of the scanned image data are separately obtained from the user by the MFP 100. Thus, the scanned image data can be securely stored. The appropriate access privileges may be set for the folder storing the image data. For example, the user can designate that the mask-combined image data and the scanned image data are stored in separate folders. In addition to or instead of, the user can designate that the scanned image data is stored in a folder different from the folder where another scanned image data is stored. This can help prevent other users from viewing the scanned image data of the user.

### Second Embodiment

The second embodiment will now be described. Hereinafter, differences with the first embodiment will be described, and matters that are the same as in the first embodiment will not be described. The second embodiment is different from the first embodiment in terms of the storage destination designation method. Specifically, in the second embodiment, instead of the output confirmation screen 800, the output confirmation screen 1200 is displayed.

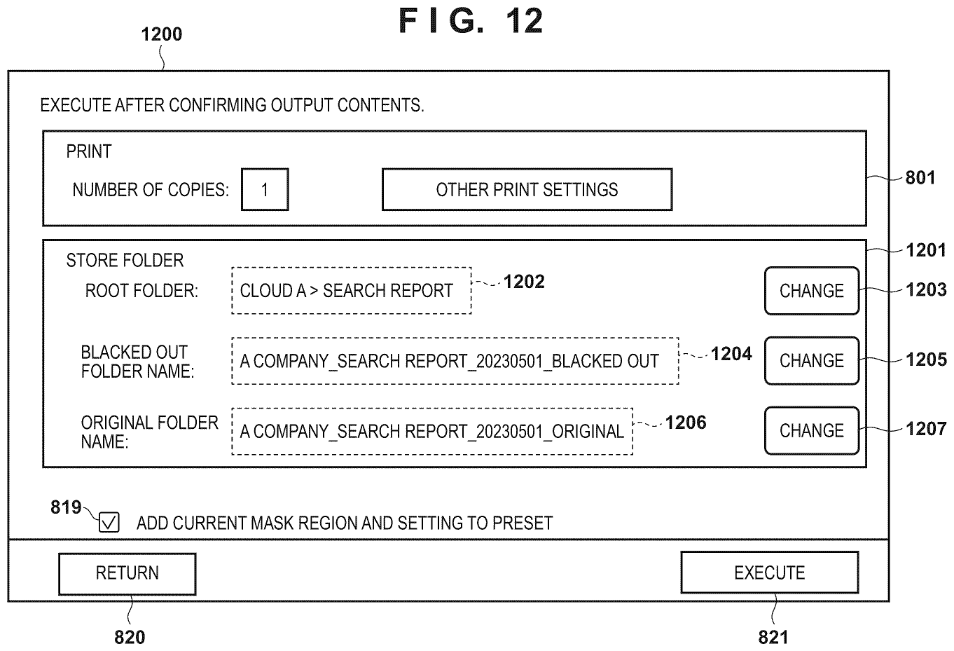

An example of the output confirmation screen 1200 will now be described with reference to FIG. 12. The output confirmation screen 1200 may be the same as the output confirmation screen 800 except in that it includes a folder designation area 1201 instead of the folder designation area 802 and the file name designation area 803.

The folder designation area 1201 includes an object for confirming and changing the storage destination of the output image data. The folder designation area 1201 may be displayed only in a case where store has been designated as the output method by the user. In the example of FIG. 12, the folder designation area 1201 includes a display field 1202 indicating the root folder of the storage destination currently set for the output image data and a change button 1203 for obtaining an instruction to change the root folder. Also, the folder designation area 1201 includes a display field 1204 indicating the folder name (in FIG. 12, “blacked out folder name”) of the storage destination currently set for the mask-combined image data and a change button 1205 for obtaining an instruction to change the folder name. Furthermore, the folder designation area 1201 includes a display field 1206 indicating the folder name (in FIG. 12, “original folder name”) of the storage destination currently set for the scanned image data and a change button 1207 for obtaining an instruction to change the folder name. These objects relating to the scanned image data may be displayed only in a case where storage of the scanned image data has been instructed by the user.

In the second embodiment, the storage destination of the image data may be specified by the storage service name, the folder path of the root folder, and the folder name. To make the storage destination easily recognizable for the user, the MFP 100 may display the folder path of the root folder after the storage service name as illustrated in FIG. 12. For example, as displayed in the display field 1202 of FIG. 12, the set storage service name is “cloud A”, and the folder path of the root folder is “search report”.

In response to the change button 1203 being pressed by the user on the output confirmation screen 1200, the MFP 100 displays a storage destination settings screen 900 on the operation unit 111. The operation of the storage destination settings screen 900 when the change button 1203 is pressed is similar to the operation described above in the first embodiment of the storage destination settings screen 900 when the change button 812 is pressed. In response to the button 905 being pressed by the user, the MFP 100 closes the storage destination settings screen 900 and displays the output confirmation screen 1200. The MFP 100 changes the currently set root folder to a combination of storage service currently selected in the pull-down list 901 and the folder path designated in the display field 902. The MFP 100 changes the display of the display field 1202 to the new root folder.

In response to the change button 1205 being pressed by the user on the output confirmation screen 1200, the MFP 100 displays a name settings screen 1000 on the operation unit 111. The operation of the name settings screen 1000 when the change button 1205 is pressed is similar to the operation described above in the first embodiment of the name settings screen 1000 when the change button 816 is pressed. In response to the button 1007 being pressed by the user, the MFP 100 closes the name settings screen 1000 and displays the output confirmation screen 1200. The MFP 100 changes the folder name currently set for the mask-combined image data to the name designated in the display field 1001. The MFP 100 changes the display of the display field 1204 to the new folder name.

In response to the change button 1207 being pressed by the user on the output confirmation screen 1200, the MFP 100 displays a name settings screen 1000 on the operation unit 111. The operation of the name settings screen 1000 when the change button 1207 is pressed is similar to the operation described above in the first embodiment of the name settings screen 1000 when the change button 816 is pressed. In response to the button 1007 being pressed by the user, the MFP 100 closes the name settings screen 1000 and displays the output confirmation screen 1200. The MFP 100 changes the folder name currently set for the scanned image data to the name designated in the display field 1001. The MFP 100 changes the display of the display field 1206 to the new folder name.

As described above, in the second embodiment, obtaining a designation of the storage destination of the mask-combined image data from the user including obtaining a designation of the folder path of the root folder and a designation of the name (folder name) of the folder storing the mask-combined image data. In a similar manner, obtaining a designation of the storage destination of the scanned image data from the user including obtaining a designation of the folder path of the root folder and a designation of the name (folder name) of the folder storing the scanned image data. The user can select the folder path of the root folder using the storage destination settings screen 900 from an existing folder that is part of the storage service. On the other hand, the user can designate any name of the folder storing the output image data using the name settings screen 1000. The MFP 100 may report an error in a case where the folder name designated by the user does not satisfy the naming convention specified by the storage service.

In response to the button 821 being pressed by the user on the output confirmation screen 1200, the MFP 100 determines the folder path of the folder of the storage destination of the output image data and the file name. For example, for the mask-combined image data, the folder path of the storage destination is determined by the MFP 100 by adding the folder name designated in the display field 1204 to the folder path of the root folder designated in the display field 1202. Also, the MFP 100 may determine the file name of the output image data on the basis of the folder name of the storage destination. For example, the MFP 100 may determine, as the file name, a character string obtained by adding an extension of the file format designated by the user to the end of the folder name designated in the display field 1204 for the mask-combined image data. The same applies for the scanned image data. Alternatively, as in the first embodiment, the output confirmation screen 1200 may include the file name designation area 803. The MFP 100 may obtain a designation of a file name from the user via the file name designation area 803. The MFP 100 may determine the file name of at least one of the mask-combined image data and the scanned image data on the basis of the folder name of the storage destination.

In the second embodiment, the MFP 100 may further store the root folder set in the display field 1202 of the output confirmation screen 800 in the column 1106 of the preset information 1100 when S311 is executed.

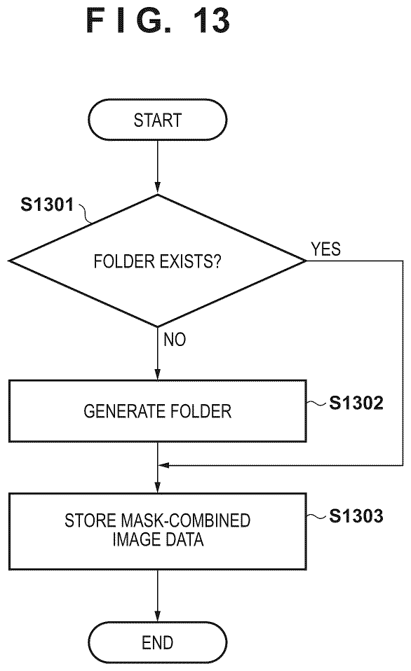

In the second embodiment, the MFP 100 may execute the operations illustrated in FIG. 13 as S315. In S1301, the MFP 100 determines whether or not a folder having the folder name designated by the user as the storage destination of the mask-combined image data exists in the storage server 120. In a case where it is determined that such a folder does exist in the storage server 120 (“YES” in S1301), the MFP 100 transitions the processing to S1303. In a case where it is determined that such a folder does not exist in the storage server 120 (“NO” in S1301), the MFP 100 transitions the processing to S1302.

In S1302, the MFP 100 generates a folder having the folder name designated by the user as the storage destination of the mask-combined image data under the root folder of the storage destination currently set for the mask-combined image data. Specifically, the MFP 100 requests the storage server 120 to generate such a folder.

In S1303, the MFP 100 stores the mask-combined image data in the folder having the folder name designated by the user as the storage destination of the mask-combined image data. In a case where S1302 is executed, the mask-combined image data is stored in the newly generated folder. In a case where S1302 is not executed, the mask-combined image data is stored in the existing folder.

In the second embodiment, the MFP 100 may execute the operations illustrated in FIG. 13 as S317. In the operations of FIG. 13, the scanned image are used instead of the mask-combined image data. In S1302, when a folder to store the scanned image is newly generated, the MFP 100 may set the access privileges of the folder on the basis of the account of the user. For example, the MFP 100 may set the access privileges so that only the user currently executing the processing of FIG. 3 can access the folder. Alternatively, the MFP 100 may set the access privileges so that only members of the group that the user currently executing the processing of FIG. 3 belongs to can access the folder.

According to the second embodiment, regardless of the folder configuration configured by the storage service, the user can discretionarily designate the name of the folder for storing the output image data. This improves the user-friendliness of the MFP 100.

### Third Embodiment

The third embodiment will now be described. Hereinafter, differences with the second embodiment will be described, and matters that are the same as in the second embodiment will not be described. The third embodiment is different from the second embodiment in terms of the storage destination designation method. Specifically, in the third embodiment, instead of the output confirmation screen 1200, an output confirmation screen 1400 is displayed.

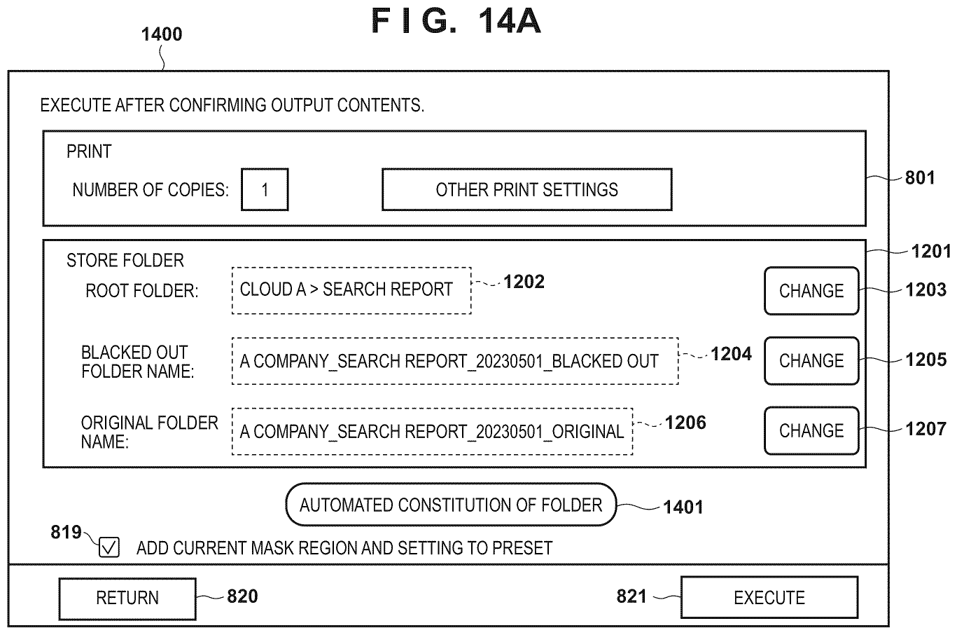

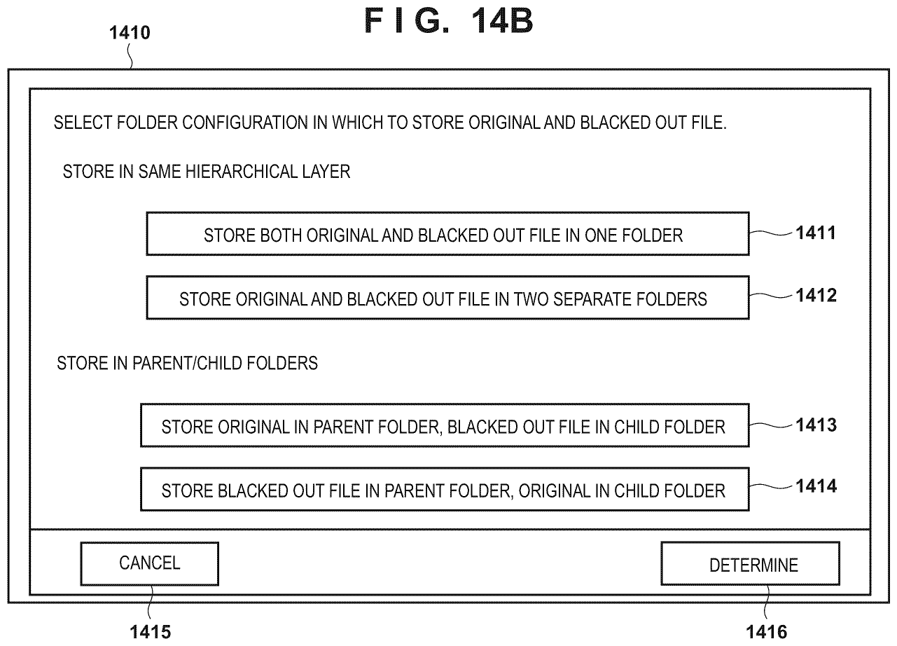

An example of the output confirmation screen 1400 will now be described with reference to FIG. 14A. The output confirmation screen 1400 may be the same as the output confirmation screen 1200 except in that it includes a folder generation button 1401. The folder generation button 1401 is an object for obtaining an instruction to automatically generate a folder of the storage destination of the output image data.

In response to the folder generation button 1401 being pressed by the user on the output confirmation screen 1400, the MFP 100 displays a folder generation screen 1410 on the operation unit 111. The MFP 100 may display the folder generation screen 1410 layered on top of the output confirmation screen 1400. An example of the folder generation screen 1410 will now be described with reference to FIG. 14B.

The folder configurations for storing the mask-combined image data and the scanned image data are broadly categorized into two configurations. One configuration stores these two types of image data in the same hierarchical layer, and the other configuration stores these two types of image data in different hierarchical layers. In the latter configuration, the two types of image data may be separately stored in two folder having a parent-child relationship.

A configuration that stores the two types of image data in the same hierarchical layer may include a configuration that stores the two types of image data in the same folder and a configuration that stores the two types of image data in different folders.

The folder generation screen 1410 may include four buttons 1411 to 1414 for obtaining a designation of the folder configuration. The buttons 1411 to 1414 may be exclusively selectable. In response to a button 1416 being pressed by the user with one of the buttons 1411 to 1414 being selected, the MFP 100 executes the processing described below according to the selected button. In this processing, the MFP 100 may use the preset settings (specifically, the name in the column 1102) selected by the user. In a case where the preset settings are used, if the preset has not been selected in S301, the MFP 100 may display the preset selection screen 410 on the operation unit 111 and obtain a selection of the preset settings from the user.

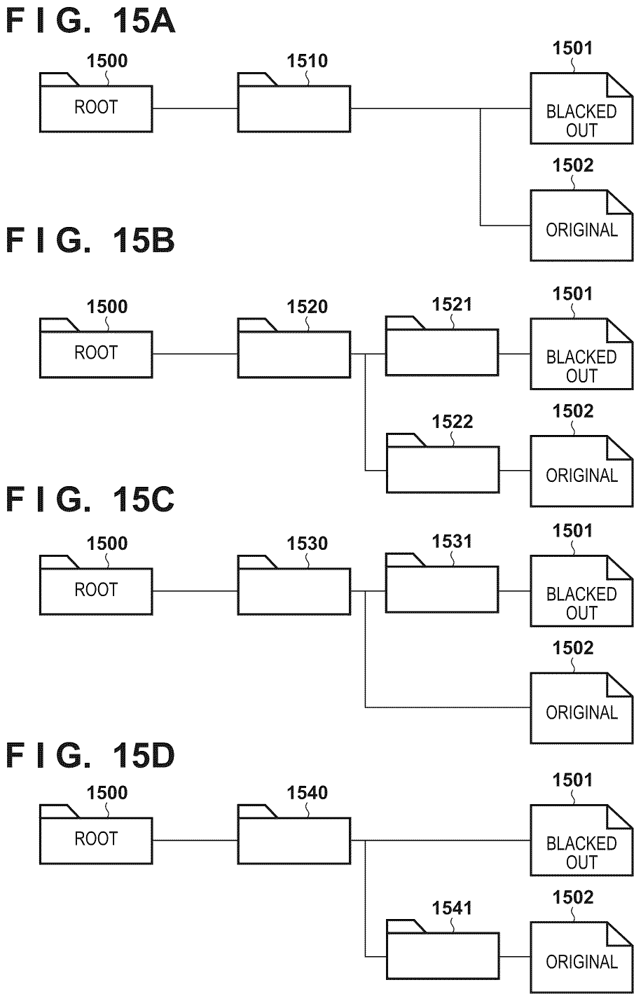

The button 1411 is for obtaining an instruction to store the mask-combined image data and the scanned image data in the same folder. In a case where the user has selected the button 1411, the MFP 100 determines to store the mask-combined image data and the scanned image data in the same folder. For example, as illustrated in FIG. 15A, the MFP 100 determines to store both a mask-combined image data 1501 and a scanned image data 1502 in a folder 1510. The folder 1510 may be directly below a root folder 1500. The root folder 1500 may be a root folder designated by the user in the folder designation area 1201.

The MFP 100 may automatically determine the name of the folder 1510. For example, a character string obtained by joining the name of the preset settings designated by the user and the current year, month, day, hour, minute with an underscore may be determined as the name of the folder 1510 by the MFP 100. For example, the name of the folder 1510 may be “A Company_search report_202305010900”. “Current” in the processing may mean the point in time when the button 1411 is pressed, the point in time when the button 1416 is pressed, or the point in time when the scanning is complete in S305. The MFP 100 stores the determined folder structure and the folder name in the RAM 104 for subsequent processing.

The button 1412 is for obtaining an instruction to store the mask-combined image data and the scanned image data in the same hierarchical layer but separate folders. In a case where the user has selected the button 1412, the MFP 100 determines to store the mask-combined image data and the scanned image data in the same hierarchical layer but separate folders. For example, as illustrated in FIG. 15B, the MFP 100 determines to store the mask-combined image data 1501 in a folder 1521 and the scanned image data 1502 in a folder 1522. Both the folder 1521 and the folder 1522 may both be directly below in a folder 1520. The folder 1520 may be directly below the root folder 1500.

The MFP 100 may automatically determine the name of the folders 1520 to 1522. The name of the folder 1520 may be the same as the name of the folder 1510 (for example, “A Company_search report_202305010900”). The MFP 100 may determine a character string obtained by joining the name of the folder 1520 and a character string (for example, “blacked out”) indicating that the mask-combined image data 1501 is stored with an underscore as the name of the folder 1521. For example, the name of the folder 1521 may be “A Company_search report_202305010900_blacked out”. The MFP 100 may determine a character string obtained by joining the name of the folder 1520 and a character string (for example, “original”) indicating that the scanned image data 1502 is stored with an underscore as the name of the folder 1522. For example, the name of the folder 1521 may be “A Company_search report_202305010900_original”.

The button 1413 is for obtaining an instruction to store the mask-combined image data in a child folder and store the scanned image data in a parent folder. In a case where the user has selected the button 1413, the MFP 100 determines to store the mask-combined image data in the child folder and the scanned image data in the parent folder. For example, as illustrated in FIG. 15C, the MFP 100 determines to store the mask-combined image data 1501 in a folder 1531 and the scanned image data 1502 in a folder 1530. The folder 1531 may be directly below the folder 1530. The folder 1530 may be directly below the root folder 1500.

The MFP 100 may automatically determine the name of the folders 1530 to 1531. The name of the folder 1530 may be the same as the name of the folder 1522 (for example, “A Company_search report_202305010900_original”). The name of the folder 1531 may be the same as the name of the folder 1521 (for example, “A Company_search report_202305010900_blacked out”).

The button 1414 is for obtaining an instruction to store the mask-combined image data in a parent folder and store the scanned image data in a child folder. In a case where the user has selected the button 1414, the MFP 100 determines to store the mask-combined image data in the parent folder and the scanned image data in the child folder. For example, as illustrated in FIG. 15D, the MFP 100 determines to store the mask-combined image data 1501 in a folder 1540 and the scanned image data 1502 in a folder 1541. The folder 1541 may be directly below the folder 1540. The folder 1540 may be directly below the root folder 1500.

The MFP 100 may automatically determine the name of the folders 1540 to 1541. The name of the folder 1540 may be the same as the name of the folder 1521 (for example, “A Company_search report_202305010900_blacked out”). The name of the folder 1541 may be the same as the name of the folder 1522 (for example, “A Company_search report_202305010900_original”).

The MFP 100 may automatically determine the file name of the mask-combined image data 1501 and the scanned image data 1502. In a case where one of the buttons 1412 to 1414 has been selected, the MFP 100 may determine a character string obtained by adding an extension of the file format designated by the user to the end of the name of the folder storing the image data as the file name. In a case where the button 1411 has been selected, the MFP 100 may determine the file names of the image data so that the mask-combined image data 1501 and the scanned image data 1502 has different file names. For example, for the mask-combined image data 1501, the MFP 100 may insert a character string (for example, “blacked out”) indicating the mask-combined image data 1501 between the folder name and the extension. For the scanned image data 1502, the MFP 100 may insert a character string (for example, “original”) indicating the scanned image data 1502 between the folder name and the extension. The MFP 100 may obtain a designation of the file name from the user instead of automatically determining the file name.

The MFP 100 stores the folder structure, folder name, and file name determined in this manner in the RAM 104 for subsequent processing. In the third embodiment, the MFP 100 may further store settings of the generation method of the folder structure designated by the user in the column 1106 of the preset information 1100 when executing S311. In this case, the MFP 100 may substitute a portion of the folder name with a variable character string. Furthermore, the MFP 100 may clearly display the folder configuration. For example, the MFP 100 may store the settings, that is a folder configuration of [(parent folder {preset name} _{year} {month} {day} {hour} {minute} _blacked out, (child folder) {preset name} {year} {month} {day} {hour} {minute} original in the column 1106. [{Preset name}] is a variable character string representing the name of the preset setting, and when this setting is used, it is replaced with the name of the preset setting designated by the user at that point in time.

In the present embodiment, the user is provided with a single object for obtaining an instruction to automatically generate the folder configuration. Thus, the user can simply select the object to designate the configuration of the folder for storing the output image data. This improves the user-friendliness of the MFP 100. Also, by automatically adding the current date and time to the folder name, the scanned image data can be stored in the folder that is different from a folder used in previous executions. This further improves the security.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-137399, filed Aug. 25, 2023, which is hereby incorporated by reference herein in its entirety.

What is claimed is:

1. An information processing apparatus comprising:
a generating unit configured to generate second image data by executing masking processing on first image data;
an obtaining unit configured to separately obtain a designation of a first storage destination and a designation of a second storage destination from a user; and
a storing unit configured to store the first image data in the first storage destination and the second image data in the second storage destination.

2. The information processing apparatus according to claim 1, wherein
the information processing apparatus is included in an image forming apparatus, and
the obtaining unit obtains the designation of the first storage destination and the designation of the second storage destination by using an operation unit of the image forming apparatus.

3. The information processing apparatus according to claim 1, wherein
the storing unit starts storing the first image data and storing the second image data in response a single instruction from the user.

4. The information processing apparatus according to claim 1, wherein
the storing unit determines a file name for at least one of the first image data and the second image data based on a folder name of a storage destination.

5. The information processing apparatus according to claim 1, wherein
separately obtaining the designation of the first storage destination and the designation of the second storage destination from the user includes separately obtaining a designation of a first folder name and a designation of a second folder name from the user, and
the storing unit
in a case where a folder having the first folder name does not exist, generates a first folder having the first folder name and stores the first image data in the first folder, and
in a case where a folder having the second folder name does not exist, generates a second folder having the second folder name and stores the second image data in the second folder.

6. The information processing apparatus according to claim 5, wherein
the storing unit sets access privileges for the second folder based on an account of the user when the second folder is generated.

7. The information processing apparatus according to claim 1, wherein
the obtaining unit provides to the user a single graphic object for obtaining an instruction to store the first image data and the second image data in a same folder from the user.

8. The information processing apparatus according to claim 1, wherein
the obtaining unit provides to the user a single graphic object for obtaining an instruction to store the first image data and the second image data in separate folders from the user.

9. A non-transitory storage medium that stores a program for causing a computer to function as the information processing apparatus according to claim 1.

10. An information processing method comprising:
generating second image data by executing masking processing on first image data;
separately obtaining a designation of a first storage destination and a designation of a second storage destination from a user, and
storing the first image data in the first storage destination and the second image data in the second storage destination.
